(19) United States
(12) Patent Application Publication
(10) Pub. No.: US 2020/0284287 A1
(43) Pub. Date: Sep. 10, 2020

(54) FASTENER SYSTEMS WITH OVERTIGHTENING AND LOOSENING PREVENTION

(71) Applicant: Philip BOGRASH, Or Akiva (IL)

(72) Inventors: Philip - Bogrash, Or Akiva (IL); Mark Bakker, Waddinxveen (NL)

(21) Appl. No.: 16/337,429

(22) PCT Filed: Sep. 28, 2017
(86) PCT No.: PCT/IL2017/051095

§ 371 Date: Mar. 28, 2019

Related U.S. Application Data
(60) Provisional application No. 62/385,966, filed on Sep. 10, 2016.
(60) Provisional application No. 62/458,284, filed on Feb. 13, 2017.
(60) Provisional application No. 62/505,867, filed on May 13, 2017.
(60) Provisional application No. 62/533,004, filed on Jul. 15, 2017.

(51) Int. Cl. F16B 31/02; F16B 39/26

(52) U.S. Cl. CPC F16B 31/028; F16B 39/26

(57) ABSTRACT

In a number of embodiment the washers of this invention have been provided with the narrowing central hole wherein the washer is being compressed during tightening thereby gripping the bolt and preventing its further turning whereas the nut and the washer are immobilized relative to each other. In another embodiments when the washer is compressed, wedges and preventing its further turning and thus preventing any increase in tightening level. Stoppers are also provided which are put on top of the embodiments with a nut having cuts along parts of its length in combination either with a flat or cup washer for compressing the nut radially and thus gripping the bolt at a predetermined axial load/torque level, as well as a nut having a cut through the middle and two footers which flexes when acted upon by axial load of predetermined level and reaction forces from the two footers gripping the bolt

### 1. FIELD OF THE INVENTION

This invention relates to nuts, washers and particularly to nuts and washers intended to prevent overtightening and loosening.

### 2. DESCRIPTION OF THE PRIOR ART

Thread overtightening routinely leads to thread damage or leveling, furthermore it very often results in damaging the work parts being held by the threaded connection. Such damages are especially common in cases where the work parts are made of less strong materials such as plastics, non-ferrous metals and wood. In our Patent Application PCT/IL2016/050913 titled “Washers for Over-tightening Prevention and Mitigation”, a number of solutions based on jamming the nut upon reaching the required axial force and torque are described. However different solutions to overtightening prevention not involving nut jamming are possible and in many cases may be cheaper, while also providing the enhanced prevention of loosening. Also nut jamming techniques can be further developed to jam the nut from the top to prevent its loosening. The solutions to overtightening and loosening prevention that we offer now generally involve gripping the bolt while also maintaining a hold of the nut. Also in cases where the nut is stationary and/or not accessible; such as pressed or inserted into a work part or where a bolt or screw is used without the nut, different solutions; focusing on stopping the bolt upon reaching the required axial force, are needed.

### 3. OBJECTS AND ADVANTAGES

One object of the present invention is to provide, for the threaded connections where nut is not accessible for tightening, an embedded washer deforming under compression during tightening and gripping the bolt thereby preventing any further tightening of the bolt once the designated axial force in the threaded connection has been reached.

Another object of the present invention is to provide for the threaded connections a washer, to be placed onto the nut, which deforms under compression during tightening gripping the bolt thereby preventing any further tightening of the threaded connection once the designated axial force in the threaded connection has been reached.

Another object of the present invention is to provide for the threaded connections a washer which when deforming under compression during tightening, is gripping the bolt, while acquiring a hold of the nut, thereby preventing any further tightening of the bolt once the designated axial force in the threaded connection has been reached.

Another object of the present invention is to provide a washer with wedges around the central hole, with said wedges designed to penetrate the clearance between the bolt and a hole wall or washers central hole's edge thereby through the wedging effect preventing further tightening of the bolt upon reaching the designated level of axial load.

Another object of the present invention is to provide the nut with a compressible collar and a cup washer placed on said collar, whose central hole will narrow when flattening, compressing the collar onto the bolt and thus preventing nut's loosening.

Another object of the present invention is to provide the nut with cuts running parallel to its length axis also extending through its collar and a cup washer to be placed on said collar, whose central hole will narrow when flattening upon reaching the designated axial load level, compressing the collar and the nut onto the bolt and thus preventing nut's further tightening and any subsequent loosening.

Another object of the present invention is to provide a nut with at least one cut across it and footers under it on 2 sides so that the reaction forces from footers will bend the nut upon reaching the designated axial load, thereby gripping the bolt and preventing over-tightening as well as subsequent loosening.

Another object of the present invention is to provide a stopper to be placed on top of the already tightened nut, with said stopper having a sharpened spur intended to enter between the end of nut's thread and bolt's thread channel's bottom jamming the nut and preventing its loosening.

Another object of the present invention is to provide a nut with cuts parallel to its length axis and a compressible collar with said collar's beveled tip intended to enter a washer's central hole thereby causing the nut and its collar's compression thus gripping the bolt, preventing overtightening at the designated axial load level and preventing subsequent loosening.

Another object of the present invention is to provide a nut with cuts parallel to its length axis, collar and footers on the bottom wherein when the nut compresses narrowing the cuts, a holder ring is placed onto its collar on its top to prevent loosening.

### 4. BRIEF DESCRIPTION OF THE DRAWINGS

FIG. 1 is the side view of the cupped grip-washer with nut in socket and bolt.

FIG. 1A is the side view of a washer with nut cup.

FIG. 1B is the top view of a washer with upward facing tabs

FIG. 1C is the side view of a washer with upward facing tabs.

FIG. 1D is a top view of washer with perimeter tabs turned outward.

FIG. 1E is the side view of a washer with downward facing tabs.

FIG. 2 is the side view of washer with wedging tabs on central hole's edge.

FIG. 3 is the side view of washer with wedging tabs.

FIG. 4 is a partial top view of washer with hammerhead wedges.

FIG. 5 is a side view of a nut with cut collar and belleville washer.

FIG. 6 is a side view of a collared cut nut with belleville washer.

FIG. 7—side view of a cut hexagonal nut with footers.

FIG. 8 is a side view of a top stopper washer.

FIG. 9 is a top view of a top stopper washer.

FIG. 9A—wire stopper on top of nut.

FIG. 9B—top view of a nut with indentations track

FIG. 10—hexagonal cut nut with a holder ring on top.

FIG. 11—hexagonal cut nut with collar pushed into flat washer.

### 5. DESCRIPTION

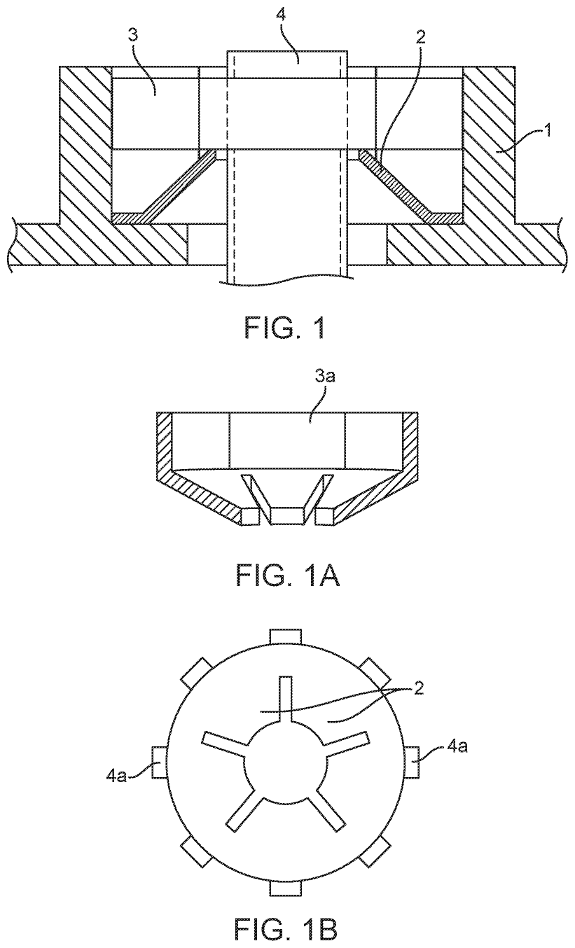

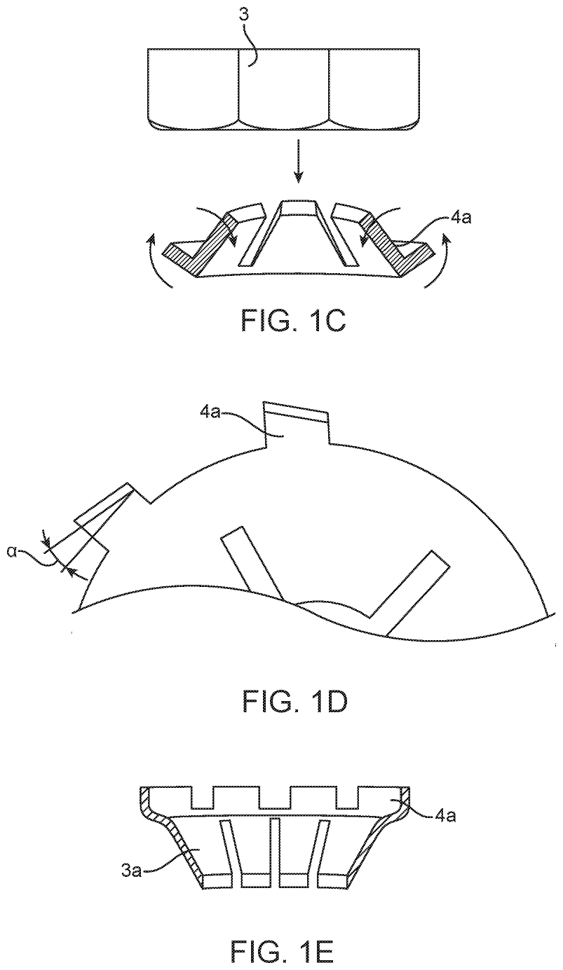

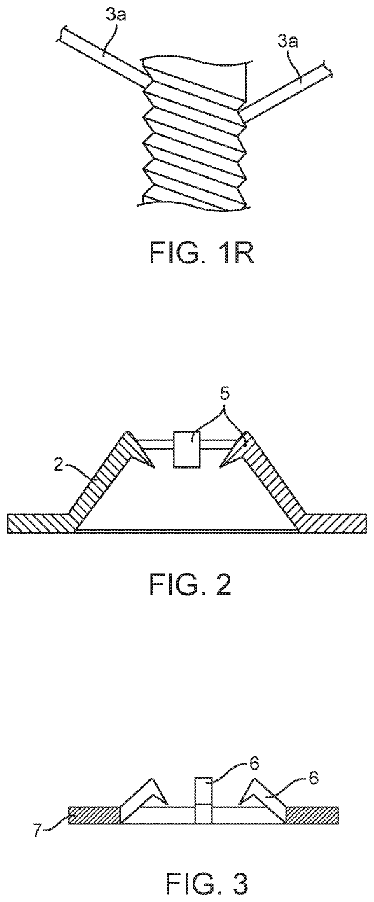

The first embodiment's first version of this invention (FIG. 1) is a washer for use with nuts embedded into hexagonal or other suitable shape socket (1) in the work part. The washer has a hexagonal or other suitable outline and has concave such as for example conical central part (2) with a central hole. The washer or at least its concave part is made of material of predetermined thickness and height from its base to the top, so that when it is pressed on by the nut (3) during bolt (4) tightening it flattens, when the nut's pressure on it and therefore the axial force in the threaded connection reach the designated level. When the washer flattens its central hole narrows gripping the bolt and, as the hexagonal washer in a hexagonal socket is not turnable, preventing bolt's further turning and therefore the connection's further tightening. Optionally the washer's central hole can be provided with a small number of radial slits or narrow cut outs radially directed (not shown) along the perimeter of central hole to promote greater narrowing of the central hole when the washer flattens. As the washer's thickness along the perimeter of its central hole is equal or greater than the bolt thread's pitch there will be no washer edge penetration into the thread channel and the washer will grip the threaded bolt shank on the outside. However in a second version of this embodiment (FIG. 1R), if due to the relatively low required axial force and torque limit the washer's thickness is significantly less than the thread pitch, then the central hole's edge needs to have at least several radial slits or narrow radially directed cutouts (not shown) of predetermined length, so that when the central hole narrows, some of the tabs (3a) formed by the slits/cutouts will be pushed above the thread ridge, while others will be pushed below said ridge; thus the thread coil will pass between said tabs when intersecting their plane. The tabs will then, as the central hole further narrows by a predetermined amount, butt up against the thread channel's bottom with a predetermined force thus gripping the bolt and preventing its further turning thereby preventing further tightening. A third version of this embodiment (FIG. 1A) will be similar to washers of the first or second versions of this embodiment but will differ from them by having a vertical wall (3b) along the washer perimeter which will form a cup-like shape with outline matching that of the nut; that is usually hexagonal. The vertical wall may optionally have a horizontal shelf along its perimeter (not shown) of a predetermined width, for increased washer structural stiffness. The cup-like wall will be of size permitting the preferably snug placement of the washer onto the lower part of the nut facing the work part, thereby preventing any relative turn movement between the washer and the nut. Thus when the washer under compression grips the bolt, no relative movement between the nut and the bolt will be possible and the possibility of loosening due to vibration will be largely eliminated. The fourth version of this embodiment will be similar to the washers of the first three versions as concerns the part of it with a central hole designed to grip the bolt when compressed. It will differ from them (FIG. 1B, FIG. 1C) by having tabs (4a) spaced along the outer perimeter of the washer at predetermined distances. These tabs (4a) will be at a predetermined angle upward (towards the nut) relative to the adjacent surface part of the washer. Said tabs may optionally be turned at a predetermined angle relatively to the tangent to the exterior perimeter of the washer (FIG. 1D) in order to enable the beveled nut's corners to push outward the tabs at the final stage of tightening when it comes into contact with them, but to prevent such outward pushing of tabs due to vibration which would produce loosening, while still making it possible to push them outward in the beginning of the unscrewing process when a sufficient torque is applied to unscrew the nut. Alternatively the washer of this embodiment can be implemented with the central cone/tabs extending downward towards the work part (FIG. 1E); in that case the central hole or tabs will narrow inclining towards and gripping the bolt, while the tabs at the outer edge of the washer will be turning outwards into a predetermined position to receive and hold the bottom part of the nut. The washer of this embodiment can also be used if it is not immobilized together with a nut for example in case of the bolt being screwed directly into a work part—in that case the washer needs to be prevented from turning by other known means, such as for example by using a pin put through a hole for it in the washer and into a matching hole in a work part being held by the threaded connection. Optionally it is possible to implement the washer of this embodiment with other compressible cross-sections that produce the narrowing of central hole. For example the cross-section between the edge of the central hole and the outer edge of the washer comprises an arch, or an upturned “V” shape etc. There can be many ways to implement the washer of this embodiment, but mutatis mutandis they are all considered to be within the spirit and scope of this invention.

The second embodiment of this invention in its first version features the (FIG. 2) wedges (5) located either on the raised central part of the washer along the edge of the central hole's perimeter or (FIG. 3) at the end of tabs (6) that are extending radially from the washer's base (7). The tabs and/or washer material comprising its raised central part are of predetermined thickness to assure that they are pushed into the horizontal or nearly horizontal position by the bolt head or nut, when the axial force in the threaded connection reaches the designated level. When the raised central part of the washer and thus the wedges (5) located on the edge of central hole, or at the ends of tabs, are pushed down into the clearance between the threaded bolt shank and the edge of hole in the work part and through the wedging effect jam the bolt's shank and thus prevent its further turning thereby preventing any further tightening. The advantage of this version is that the washer does not need to be immobilized.

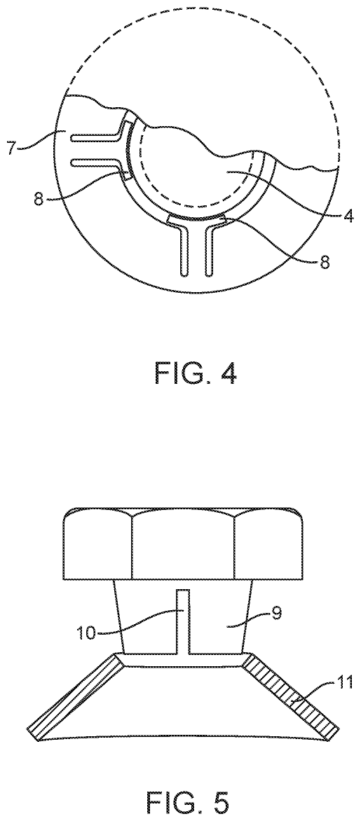

The second version of this embodiment (FIG. 4) is for the cases where the clearance between the edge of hole in a work part and the threaded shank is too narrow for insertion of a wedge of sufficient strength or the material of the work part is not strong enough for that. The wedges (8) are implemented in a shape resembling hammerheads that are bent downwards (towards the work part) and the wedging takes place between the threaded bolt's shank and the edge of the washer's base on both sides of each tab. The washer has to have a hexagonal vertical wall or tabs or flaps along its perimeter to enclose or hold the bottom part of the nut. For cases where the bolt is used alone or the nut is not accessible and the bolt is tightened, the washer needs to be immobilized by having a hexagonal, square or other suitable shape and placed into a matching or suitable socket/enclosure. Alternatively it can be immobilized by other known means such as for example a pin as was described for the first embodiment etc.

There can be many ways to implement the washer of this embodiment, but mutatis mutandis they are all considered to be within the spirit and scope of this invention.

The third embodiment of this invention will comprise a combo of a nut with an elastic belleville-type/conical washer. First version of this embodiment is designed to prevent loosening only and (FIG. 5) consists of a nut with a collar/turret; otherwise the nut is regular. Said collar (9) can be fairly thin-walled and thus compressible around the bolt or it can have greater wall thickness with at least 2 radial cuts (10) thus also enabling its compression around the bolt. The collar can be short and of constant diameter or longer by a predetermined length and with tapering diameter; narrowing from the base towards the tip to allow easy placement of the washer onto the tip.

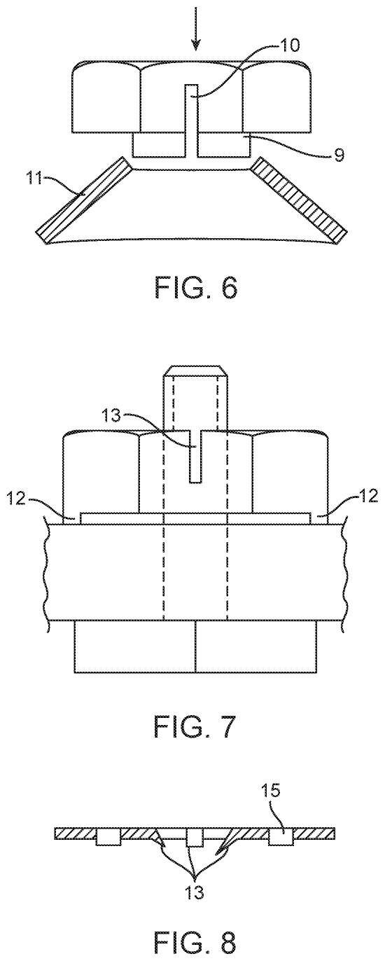

The conical washer (11) is preferably of material suitable for elastic deformation when flattening. When flattening the washers central hole narrows gripping the nut collar with sufficient predetermined level of force to assure that the nut does not loosen when subjected to vibration. To promote greater narrowing of the washer it may optionally have radially directed slits or narrow cut-outs of predetermined length and width. The second version of this embodiment (FIG. 6) is for the prevention of over-tightening as well as loosening. It will comprise a nut with a collar/turret as in the first version except the collar is stronger to withstand stronger forces, but the nut, including its collar, will have at least 2 radial cuts (10) to predetermined depth which will determine the axial load and a corresponding torque level at which it will narrow gripping the bolt with sufficient force to prevent further tightening. The conical washer is of predetermined stiffness, so that it only flattens upon reaching a designated level of axial load; it may optionally have radially directed slits or narrow cut-outs (not shown) to enable more pronounced narrowing of its central hole. When the washer flattens its central hole narrows and it compresses the nut collar with sufficient force to narrow it so that the nut cuts narrow and thus the nut grips the bolt thus preventing further tightening. The advantage of this design is that the tightening proceeds without undue resistance until the designated level of axial force is reached, at which point further tightening is blocked.

The nut of the fourth embodiment (FIG. 7) has footers (12) and a cut (13) to allow flexibility of the nut when it is acted upon by the axial load in the middle and the reaction forces from the footers (12). The cut to a predetermined depth can be either complete from one nut facet to the other or it can be made on only one side of the nut; from one facet to the central hole. Alternatively there can be more than one cut between different opposing pairs of nut facets. Still another possibility is to have a cut which does not fully cover the distance between the facet and central hole, but rather leaves a relatively thin uncut connection between the two edges of the cut. This kind of cut can be implemented on either both opposite facets of the nut or just on one depending on the expected loads acting on the nut. Other possibilities include sloping of footers along their length or the use of footers of unequal height or just one footer—these options are all intended to skew the nut's thread relative to that of the bolt to enhance the braking action. Footers (12) can be located within the hex nut outline preferably closer to the diagonally opposite corners of the nut, so as to maximally increase the distance between them. Alternatively (not shown) they can be a part of lugs extending beyond the nut's hex outline, preferably in said diagonally opposed corners areas or be comprised by remaining, uncut segments of the flange of a flange nut. To prevent excessive narrowing of the nut during tightening, which can cause wrench slippage and nut corners damage, the clearance between the nut's threaded internal surface and the bolt's threaded external surface is best minimized, just enough to allow their relative movement.

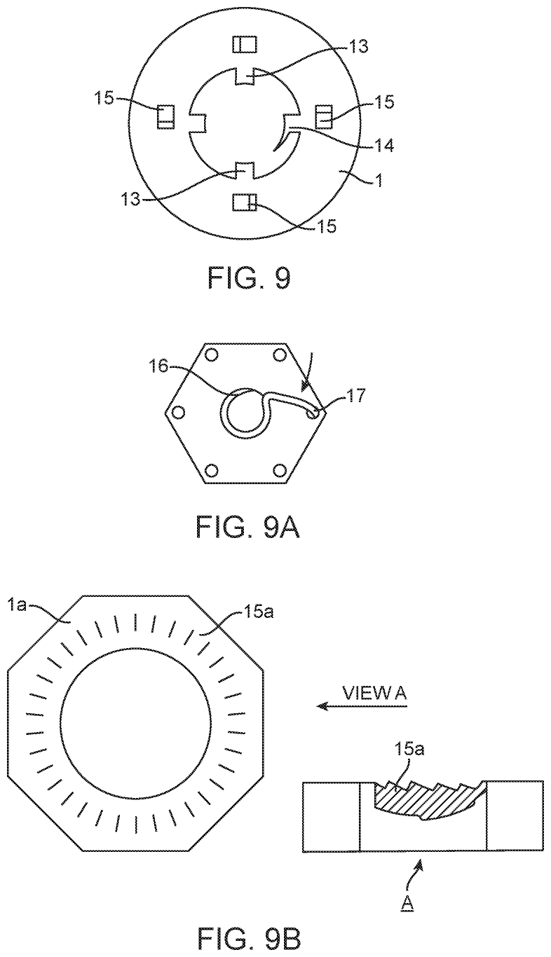

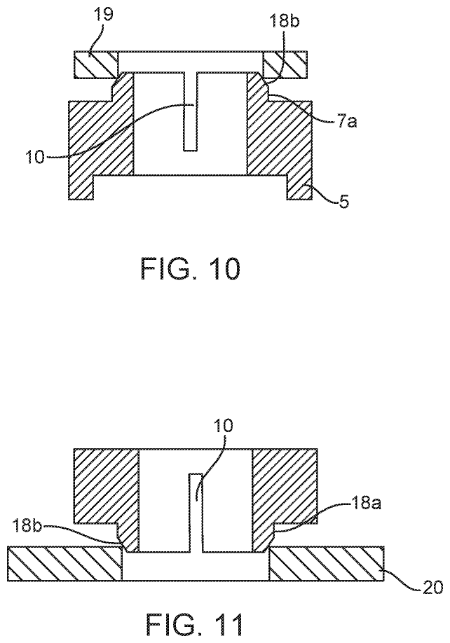

The fifth embodiment is a washer (FIG. 8 and FIG. 9) for preventing any loosening of the nut, which has at least 2 tabs (13) bent downward at different angles corresponding to their location along the thread coil. The lowest tab (14) has a spur which is meant to enter tangentially into the narrow opening between the nut thread's trailing end and the bottom of bolt's thread channel, wherein it will jam the nut preventing any backward, loosening movement by said nut. To prevent backward movement by the screwed onto the bolt jam washer, said jam washer (FIG. 9B) has ratcheting flaps bent downward (15) and indented track (15a) on the nut's top surface. For the regular nut lacking such indented track, a different version of the jam washer can be used (not shown) comprising flaps or tabs on the sides, possibly having interrupted cuts along their bases. In operation once the jamming of the nut has been accomplished the tabs or flaps are bent to press tightly against the facets of the nut thereby immobilizing the washer relatively to the nut and thus also keeping the nut jammed and thereby prevented from loosening. The third version of a jam washer is a wire loop or at least one coil (FIG. 9A) with internal diameter corresponding to that of the bolt, one pointed end of which (16) is bent to enable it to enter the clearance between the trailing end of the nut's thread and the bolt thread channel's bottom. The other end of said wire (17) is not pointed and is intended to be elastically flexed and inserted into a hole, indentation or pit etc on the top surface of the nut in a way assuring that there is a torque within its predetermined level range around the bolt shank causing the pointed end (16) to be pressing into the above referenced clearance with an elastic force thus producing a wedging effect, thus preventing nut loosening. There are other solutions to affix the other, non-sharp end of the wire to the nut such as forming it into a hexagonal or other suitable shape loop either complete or partial and pressing it onto the nut etc. There can be many ways to implement the washer/stopper of this embodiment, but mutatis mutandis they are all considered to be within the spirit and scope of this invention. The sixth embodiment's first version (FIG. 10) is a nut similar to the nut described in the fourth embodiment with at least two footers and at least one cut. On its top it has a collar or turret (18) consisting of cylindrical part (18a) and optionally conical part (18b). Holding ring (19) is placed over cylindrical part (18a) upon completion of the tightening. Alternatively this version can be implemented without a distinct turret with conical part (18b) and cylindrical part (18a) cut on the body of the nut.

The second version of this embodiment (FIG. 11) is a nut with at least one cut without the footers, wherein the turret has a conical part (18b) designed to enter the central hole of washer (9) and the cylindrical part (18a) of predetermined diameter which is appropriate for its entering the washer upon completion of the tightening after the nut's bottom facing the washer (20) has narrowed by a predetermined amount due to the conical part (18b) entering the washer first. Optionally the washer (20) may have gently curled elastic tabs (not shown) pressing against the bottom of nut for throwing off the washer from the nut's turret when it is being unscrewed.

### 6. SKETCHES AND DIAGRAMS

Provided separately

### 7. OPERATION

For the first embodiment the operation of washer was adequately described in the Description section and will not be reiterated here, but is included by way of reference as if fully set forth.

For the second embodiment the operation of washer was adequately described in the Description section and will not be reiterated here, but is included by way of reference as if fully set forth.

For the third embodiment the operation of washer and nut combination was adequately described in the Description section and will not be reiterated here, but is included by way of reference as if fully set forth.

The nut of the fourth embodiment's first version will be subjected while being tightened to the axial load from the bolt and the reaction forces from the footers causing it to flex a pre-determined amount where the cut is located thereby gripping the bolt with a pre-determined force and thus limiting its further tightening. The deeper the cut the greater the flexibility of the nut and accordingly the lower the level of the axial load at which the nut will grip the bolt. Such gripping is likely in many cases to cause plastic deformation of the uncut area under the cut which will cause the enhanced gripping action counteracting loosening even when the nut of this embodiment is not being used for torque and/or axial load limiting or overtightening prevention.

The operation of the second version of this embodiment is adequately described in the Description section and will not be reiterated here but is included by way of reference as if fully set forth.

The operation of the washer of the fifth embodiment has been adequately described in the Description Section and will not be re-iterated here, but is included by way of reference as if fully set forth

The operation of sixth embodiment's first version is taking place in much the same way as the operation of the fourth embodiment except that at the end of tightening holding ring (19) may optionally be first placed onto the conical part (18b) and then (or directly if no conical part is present) is placed onto the turret's cylindrical part (18a) to bracket it and to prevent the nut's cut(s) from re-opening and thus losing their grip. Second version lacks the footers and therefore nut's bottom narrowing takes place when the turret's conical part (18b) enters the washer (20) and then conical part moves deeper into the washer. Final stage of tightening stops and the washer stays in position relative to the nut when it has reached and is bracketing the nut turret's cylindrical part (18a).

What claimed is:

1. A washer with at least one structural component for exerting pressure on the bolt shank when said structural components undergo predetermined deformation during tightening, with said washer also having structural feature for its immobilization relative to pertinent components of the threaded connection, whereby upon reaching a pre-determined level of axial load said components pressure acts as a brake on the bolt, preventing any further tightening.

2. The washer of claim 1 wherein said structural component for exerting pressure on the bolt is a raised central part of the washer with washer's hole at its center, whereby during tightening said raised central part flattens and the central hole narrows gripping the bolt.

3. The washer of claim 2 wherein said raised central part of the washer has radial cuts starting from the edge of central hole to produce greater narrowing of the central hole during flattening.

4. The washer of claim 1 wherein said structural components for exerting pressure on the bolt are 2 or more tabs bent at a predetermined angle to the horizontal plane and located at the base of the central hole.

5. The washer of claim 1 where said structural feature for washer immobilization is said washer's non-circular outline matching the outline of a socket where it is embedded.

6. The washer of claim 1 where said structural feature for washer immobilization is a hexagonal wall for enclosing the part of the nut facing the washer.

7. The washer of claim 1 where said structural feature for washer immobilization are tabs along the outer perimeter of the washer bent at a predetermined angle to the washer's base plane.

8. The washer of claim 7 where said tabs are turned at a predetermined angle to the tangent to washer perimeter line to make it possible to easily tighten the nut, but requiring significant torque to unscrew thereby preventing its unintentional loosening.

9. The washer of claim 1 where said structural component for exerting pressure on bolt shank is at least one wedge-shaped tab for entering the clearance between the edge of hole in a work part and the bolt shank located on the edge of washers central hole.

10. The washer of claim 1 where said structural component for exerting pressure on bolt shank is a wedge-shaped tip of at least one tab turned at a predetermined angle in the direction where it will encounter the clearance between the bolt shank and the edge of hole in a work part, with said tab base located on the edge of central hole.

11. The washer of claim 1 where said structural component for exerting pressure on bolt shank is a wedge-shaped tip of at least one raised tab turned at a predetermined angle in the direction where it will encounter the clearance between the bolt shank and the edge of washer, whereas said washer has a feature for its immobilization.

12. A nut and washer combination wherein the nut has a collar, with said nut having at least one radially directed cut between its outside perimeter and the inner surface of its central hole to a predetermined depth, said cut starts from the collar end and goes to a predetermined depth, whereas a washer is placed on said collar.

13. The nut and washer combination of claim 12 wherein only the collar has at least one radially directed cut and the washer placed on the collar is a cup washer, whereby said cup washer's central hole narrows when it flattens thus gripping the collar and the bolt inside of it locking the connection and preventing its loosening

14. The nut and washer combination of claim 12 wherein the nut together with the collar has at least one radially directed cut to a predetermined depth and the washer placed on the collar is a cup washer, whereby said cup washer's central hole narrows when, upon reaching the designated level of axial load, it flattens and the collar is gripped together with the bolt inside the nut and the collar thus preventing further tightening and subsequent loosening.

15. A stopper and a nut combination comprising an enclosure of central hole, a sharp jammer element attached to said enclosure and intended to enter the clearance between the trailing end of nut's thread and the bottom of thread channel on the bolt and the structural elements of both the stopper and the nut for immobilizing the stopper relative to the nut.

16. The stopper of claim 15 wherein said enclosure of central hole is a washer base, wherein said washer has tabs that enter the bolt thread and the tab closest to the nut top has said sharp jammer element, whereas the stopping elements are comprised of at least one flap on the washer in mesh with the track with indentations on top of the nut.

17. The stopper of claim 15 wherein said enclosure of central hole is a washer base, whereas said washer has tabs that enter the bolt thread and the tab closest to the nut top has said sharp jammer element, whereas said stopping elements are comprised of at least one bendable element to be pressed against nut facet once the jammer has been pushed into said clearance jamming it.

18. The stopper of claim 15 wherein said enclosure of central hole is comprised by at least one wire loop, whereas said sharp jammer element is comprised by the sharp end of said wire, whereas the stopping element is comprised of the other end of said wire configured to become affixed to the nut's matching feature.

19. The nut and washer combination of claim 12 wherein the nut also has at least two opposing footers at its bottom facing the work part and a washer is placed on said collar upon completion of tightening to prevent loosening.

20. The nut and washer combination of claim 12 wherein the collar has beveled edge whereby the nut's collar is driven into the washer's hole of predetermined smaller than the collar size during tightening, thereby compressing said collar upon reaching the designated level of axial force and subsequently preventing loosening.
